(19) United States
(12) Patent Application Publication
(10) Pub. No.: US 2026/0044102 A1
(43) Pub. Date: Feb. 12, 2026

(54) SHEET FEEDING DEVICE AND IMAGE FORMING APPARATUS

(71) Applicant: CANON KABUSHIKI KAISHA, Tokyo (JP)

(72) Inventor: AKIRA MATSUSHIMA, Shizuoka (JP)

(21) Appl. No.: 19/284,416

(22) Filed: Jul. 29, 2025

(30) Foreign Application Priority Data
Aug. 9, 2024 (JP) 2024-133936

(51) Int. Cl. G03G 15/00; G03G 15/01

(52) U.S. Cl. CPC G03G 15/6511; G03G 15/0189; G03G 15/6514; G03G 15/6558; G03G 15/657

(57) ABSTRACT

A sheet feeding device includes an device main body, a cassette including an accommodating portion configured to accommodate sheets, which is mounted on the device main body to be drawable in a draw-out direction from a housed position, a feeding unit configured to feed a sheet accommodated in the accommodating portion to a downstream side in the draw-out direction, and a movable guide configured to guide the sheet fed by the feeding unit, the movable guide being supported by the device main body to be movable in a first direction, the movable guide being arranged on a downstream side of the accommodating portion in the draw-out direction in a state where the cassette is located at the housed position. In a process of mounting the cassette on the device main body, the movable guide is moved in the first direction by the cassette.

### BACKGROUND

### Field of the Technology

The present disclosure relates to a sheet feeding device for feeding sheets and an image forming apparatus for forming images on sheets.

### Description of the Related Art

U.S. Publication No. 20150001793 corresponds to Japanese Patent Application Laid-Open No. 2015-11093 and discusses a movable guide arranged on a drawable cassette to be attached on an apparatus main body of an image forming apparatus. This movable guide is pulled down when the cassette is drawn out of the apparatus main body.

In a case where the movable guide for guiding a sheet fed from the cassette is arranged on the apparatus main body, it is desirable that the movable guide be arranged at a position close to the cassette as much as possible.

### SUMMARY

The present disclosure is thus directed to providing an image forming apparatus in which a movable guide arranged in the apparatus main body is arranged closely to a cassette.

According to some embodiments, a sheet feeding device includes a device main body, a cassette including an accommodating portion configured to accommodate sheets, the cassette being mounted on the device main body to be drawable in a draw-out direction from a housed position, a feeding member configured to feed a sheet accommodated in the accommodating portion to a downstream side in the draw-out direction, and a movable guide configured to guide the sheet fed by the feeding member, the movable guide being supported by the device main body to be movable in a first direction, the movable guide being arranged on a downstream side of the accommodating portion in the draw-out direction in a state where the cassette is located at the housed position, wherein, in a process of mounting the cassette on the device main body, the movable guide is moved in the first direction by the cassette.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating a structure for supporting a movable guide according to a first exemplary embodiment.

FIG. 2 is a perspective view illustrating an image forming apparatus according to the first exemplary embodiment.

FIG. 3 is a schematic diagram illustrating the image forming apparatus according to the first exemplary embodiment.

FIG. 4 is a schematic diagram illustrating a sheet conveyance device according to the first exemplary embodiment.

FIG. 5 is a perspective view illustrating a cassette according to the first exemplary embodiment.

FIG. 6 is a perspective view illustrating a positional relationship of the cassette and the movable guide according to the first exemplary embodiment.

FIG. 7 is a perspective view illustrating the movable guide according to the first exemplary embodiment.

FIG. 8 is a perspective view illustrating the movable guide according to the first exemplary embodiment.

FIGS. 9A and 9B are diagrams illustrating the movable guide according to the first exemplary embodiment.

FIGS. 10A to 10C are diagrams illustrating the movable guide according to the first exemplary embodiment.

FIG. 11 is a perspective view illustrating a structure for supporting a movable guide according to a second exemplary embodiment.

FIGS. 12A to 12C are diagrams illustrating the movable guide according to the second exemplary embodiment.

FIG. 13 is a perspective view illustrating a structure for supporting a movable guide according to a third exemplary embodiment.

FIGS. 14A to 14C are diagrams illustrating the movable guide according to the third exemplary embodiment.

### DESCRIPTION OF THE EMBODIMENTS

Hereinafter, various exemplary embodiments, features, and aspects according to the present disclosure will be described with reference to the attached drawings.

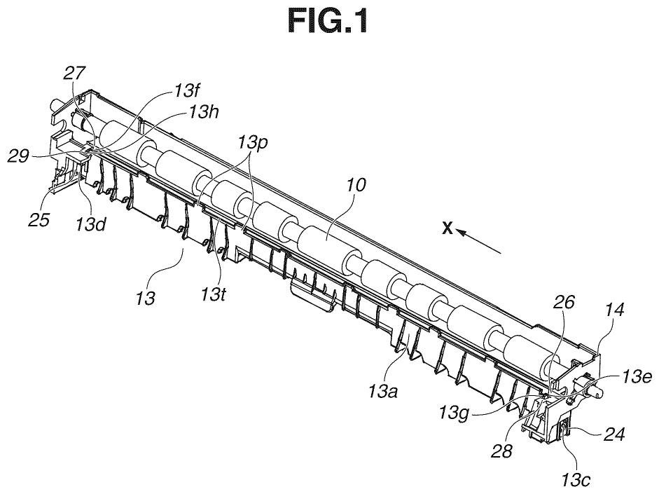

An image forming apparatus 1 according to an exemplary embodiment (first exemplary embodiment) will be described with reference to FIGS. 1 to 10C.

In the below-described descriptions and drawings, assume that a vertical direction is referred to as a Z direction in a case where the image forming apparatus 1 is installed on a horizontal plane. A direction parallel to a rotation axis line of a photosensitive drum Dr included in the image forming apparatus 1 is referred to as an X direction. A direction intersecting with both of the X direction and the Z direction is referred to as a Y direction. It is desirable that the X direction, the Y direction, and the Z direction be orthogonal to each other.

### Overview of Image Forming Apparatus

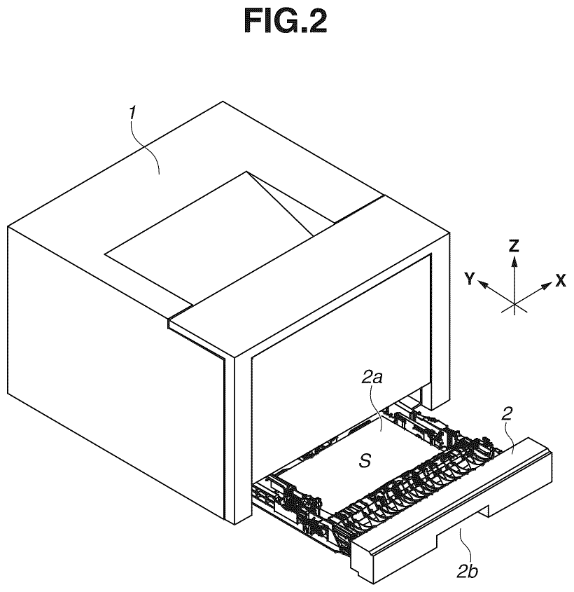

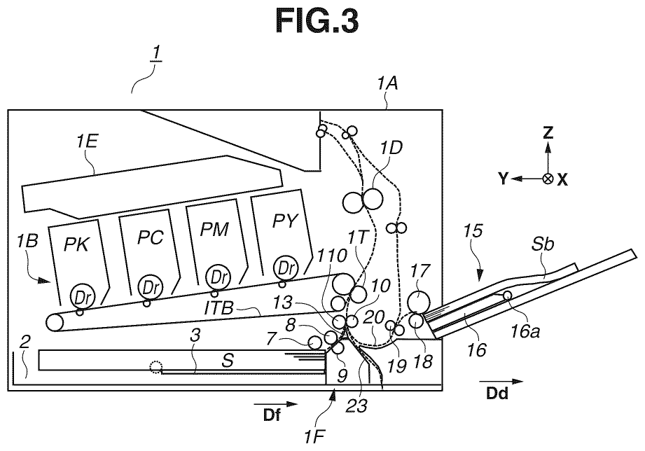

FIG. 2 is a perspective view illustrating the image forming apparatus 1. FIG. 3 is a schematic diagram illustrating a cross-sectional view of the image forming apparatus 1. As illustrated in FIGS. 2 and 3, the image forming apparatus 1 includes an apparatus main body 1A and a cassette 2. The cassette 2 is mounted on the apparatus main body 1A to be drawable in a draw-out direction Dd from the apparatus main body 1A. In the present exemplary embodiment, the apparatus main body 1A refers to a portion of the image forming apparatus 1 excluding the cassette 2.

The apparatus main body 1A includes an image forming unit 1B and a housing which houses the image forming unit 1B. The image forming unit 1B according to the present exemplary embodiment is an intermediate transfer-type tandem electrophotographic unit. In other words, the image forming unit 1B includes four process units PY, PM, PC, and PK, an exposure unit 1E, an intermediate transfer belt ITB serving as an intermediate transfer body, a secondary transfer roller 1T as a transfer member, and a fixing unit 1D. Each of the process units PY, PM, PC, and PK includes a photosensitive drum Dr serving as an image bearing body, a charging device operating on the photosensitive drum Dr, a development device, and a cleaning device.

Sheets S having various sizes and basis weights can be stacked on (accommodated in) the cassette 2. The sheet S serving as a recording material (recording medium) can be made of various sheet materials in different sizes and materials, such as standard paper, heavy paper, a surface-treated sheet material such as coated paper, sheet materials having special shapes such as an envelope and index paper, a plastic film, and a fabric.

The cassette 2 and a feeding roller 7 arranged in the apparatus main body 1A constitute a sheet feeding device 1F according to the present exemplary embodiment. The sheet feeding device 1F will be described below in detail.

An outline of a series of operations (image forming operation) through which the image forming apparatus 1 executes to form an image on a sheet S while conveying the sheet S one by one will be described. For example, the image forming apparatus 1 starts the image forming operation in a case where the image forming apparatus 1 receives an image forming instruction (printing instruction) from an external computer. In the image forming operation, the photosensitive drums Dr included in the process units PY to PK and the intermediate transfer belt ITB are driven and rotated. The charging devise electrically charges the surface of the photosensitive drum Dr. Based on image information received together with the printing instruction, the exposure unit 1E exposes the photosensitive drum Dr with light to write an electrostatic latent image on the surface of the photosensitive drum Dr. The development device supplies toner used as developer, borne on development roller, to the photosensitive drum Dr to develop the electrostatic latent image into toner image. Through this operation, toner images of yellow, magenta, cyan, and black colors are formed by the process units PY, PM, PC, and PK. These toner images are transferred (primarily transferred) to the intermediate transfer belt ITB by the voltage applied to primary transfer rollers corresponding to the respective photosensitive drums Dr. At this time, toner images of respective colors overlap each other, so that a full-color image is formed on a surface of the intermediate transfer belt ITB. This image is borne by the intermediate transfer belt ITB, and conveyed to a secondary transfer portion formed between the intermediate transfer belt ITB and the secondary transfer roller 1T.

In contrast, the sheet feeding device 1F feeds sheets S to the secondary transfer portion from the cassette 2 one by one. At the secondary transfer portion, an image is transferred (secondarily transferred) to a sheet S from the intermediate transfer belt ITB by the voltage applied to the secondary transfer roller 1T. The image formed on the sheet Shaving passed through the secondary transfer portion is fixed by heat applied from the fixing unit 1D. The sheet S having passed through the fixing unit 1D is discharged to the outside of the apparatus main body 1A by a discharge roller pair, and stacked on a discharge tray provided on the upper surface of the apparatus main body 1A.

In the above description, the image forming unit 1B is merely an example of an image forming unit for forming an image on a sheet S. The image forming unit is, for example, a direct transfer-type electrophotographic unit.

The image forming unit is not limited to an electrophotographic-type printing unit, and can be an ink jet-type printing unit.

### Sheet Feeding Device

The sheet feeding device 1F included in the image forming apparatus 1 according to the present exemplary embodiment will now be described.

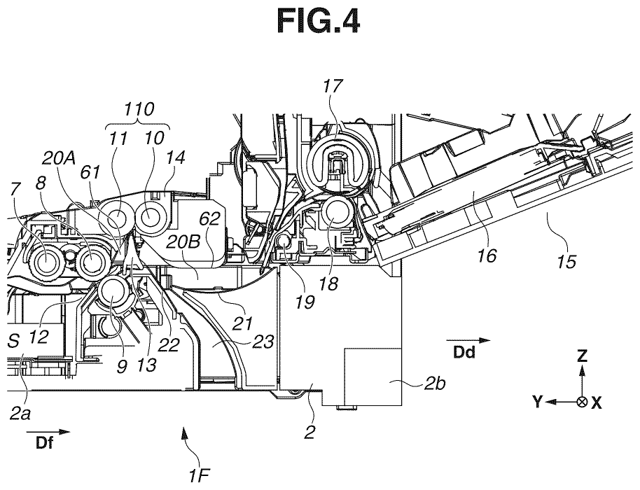

FIG. 4 is a cross-sectional view illustrating an enlarged portion of FIG. 3.

As illustrated in FIGS. 3 and 4, the sheet feeding device 1F includes a cassette 2, a feeding roller 7, a separation roller pair (8, 9), a pair of registration rollers (hereinafter, referred to as a “registration roller pair 110”), and a movable guide 13. The feeding roller 7, the separation roller pair (8, 9), the registration roller pair 110, and the movable guide 13 are arranged in the apparatus main body 1A.

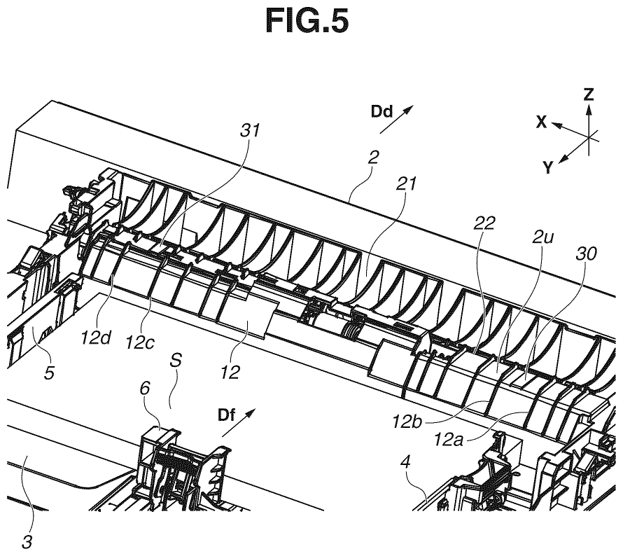

FIG. 5 is a perspective view illustrating the cassette 2 drawn from the apparatus main body 1A. As illustrated in FIG. 5, the cassette 2 includes an accommodating portion 2a (cassette frame body) configured to accommodate sheets S, a grip portion 2b (FIG. 2), an intermediate plate 3 (FIG. 3), and regulation plates 4, 5, and 6. The intermediate plate 3 and the regulation plates 4 to 6 are arranged on the accommodating portion 2a.

The grip portion 2b is gripped by the user when the user draws out the cassette 2 in the draw-out direction Dd. The intermediate plate 3 is a supporting member (stacking member) that supports a lower surface of the sheet S set to the cassette 2. The intermediate plate 3 can be moved up from and moved down to a bottom part of the accommodating portion 2a. The regulation plates 4 and 5 are a pair of regulation members for regulating the edge positions in a sheet width direction of the sheet S set to the cassette 2. The sheet width direction is a direction orthogonal to the sheet feeding direction Df the sheet S is fed from the cassette 2. In the present exemplary embodiment, the sheet width direction is same as the X direction.

The regulation plate 6 is a regulation member for regulating a trailing edge position in the sheet feeding direction Df of the sheet S set to the cassette 2. A first guide 12 is arranged on a downstream side of the accommodating portion 2a in the sheet feeding direction Df, and guides the lower surface of the sheet S fed from the accommodating portion 2a.

As illustrated in FIG. 4, the feeding roller 7 is arranged on the upper side of the accommodating portion 2a in a state where the cassette 2 is mounted on the apparatus main body 1A. The feeding roller 7 is an example of a feeding unit for feeding a sheet S from the cassette 2. In the present exemplary embodiment, the sheet feeding direction Df, in which the sheet S is fed by the feeding roller 7, is substantially the same as the draw-out direction Dd. In other words, the feeding roller 7 (feeding member) feeds the sheet S accommodated in the accommodating portion 2a of the cassette 2 to a downstream side in the draw-out direction Dd.

The separation roller pair (8, 9) consists of a feed roller 8 and a retard roller 9. The feed roller 8 abuts on the retard roller 9. The feed roller 8 further conveys the sheet S received from the feeding roller 7 in the sheet feeding direction Df. The retard roller 9 receives driving force acting in a direction opposite to the sheet feeding direction Df via a torque limiter. The retard roller 9 is an example of a separation member for separating a sheet S by applying frictional force to the sheet S at the nip portion (separation nip) formed between the feed roller 8 and the retard roller 9. For example, a pad-like elastic member (i.e., separation pad) abutting on the feed roller 8 can also be used as the separation member.

The registration roller pair 110 includes a drive roller 10 that is rotated by the driving force of a driving source (motor), and a driven roller 11 that rotates to follow the drive roller 10. The registration roller pair 110 is disposed at a position on a downstream side of the separation nip and an upstream side of the secondary transfer portion in a conveyance path extending from the cassette 2 to the discharge roller pair via the secondary transfer portion and the fixing unit 1D.

The user can supply sheets S to the cassette 2 or replace sheets S already set to the cassette 2 by drawing out the cassette 2 from the apparatus main body 1A in the draw-out direction Dd as illustrated in FIG. 2. When the cassette 2 is drawn from the apparatus main body 1A, coupling of a driving device provided in the apparatus main body 1A and a lifting mechanism of the intermediate plate 3 provided on the cassette 2 is cleared. The intermediate plate 3 thereby moves down by its own weight.

The cassette 2 drawn from the apparatus main body 1A is mounted to the apparatus main body 1A by being inserted in a mounting direction opposite to the draw-out direction Dd. The apparatus main body 1A includes a draw-in device that draws the cassette 2 into a predetermined housed position (mounting position) within the apparatus main body 1A. The force received from the draw-in device causes an abutting portion provided on a downstream end of the cassette 2 in the mounting direction to abut on the apparatus main body 1A, so that the cassette 2 is fixed at the housed position. Feeding of a sheet S from the cassette 2 is allowed in a state where the cassette 2 is located at the housed position.

By receiving a detection signal output from a sensor (not illustrated), a control unit of the apparatus main body 1A can detect that the cassette 2 is mounted on or drawn from the apparatus main body 1A. When the control unit detects that the cassette 2 is mounted, the control unit activates the driving device to move the intermediate plate 3 upward. The control unit also detects that an uppermost sheet S has reached a predetermined height by receiving a detection signal output from a sheet sensor (not illustrated), and determines that feeding of the sheet S is executable. The predetermined height refers to a height at which the sheet S can smoothly reach the separation nip by being fed through the rotation of the feeding roller 7. In a case where an amount of sheets S stacked on the intermediate plate 3 is decreased after execution of the image forming operation, the control unit controls the driving device to make the uppermost sheet S be located at the predetermined height.

When the image forming operation is started, the feeding roller 7 rotates in a state where the feeding roller 7 abuts on the uppermost sheet S, so that the sheet S is fed from the cassette 2 in the sheet feeding direction Df. The separation roller pair (8, 9) separates and conveys the sheet S fed from the cassette 2. Specifically, in a case where only one sheet S enters the separation nip, the torque limiter slips to cause the retard roller 9 to rotate by following the feed roller 8 and the sheet S. In a case where a plurality of sheets S enters the separation nip, sheets S except for the uppermost sheet S being in contact with the feed roller 8 are retarded from passing through the separation nip by the retard roller 9.

### Manual Feeding Unit

The image forming apparatus 1 according to the present exemplary embodiment includes a manual feeding unit 15 (e.g., a multipurpose feeding unit or a multi-feeding unit) as illustrated in FIGS. 3 and 4. When the user wants to use sheets S which cannot be set to the cassette 2 (e.g., thick paper and/or small-size paper) or a small amount of special sheets S, the manual feeding unit 15 allows the user to manually set and feed these sheets S from the outside of the image forming apparatus 1.

The manual feeding unit 15 includes a manual feeding tray having an intermediate plate 16, a feeding roller 17, a separation roller 18, and a conveyance roller pair 19. In a case where sheets Sb are to be fed from the manual feeding unit 15, the intermediate plate 16 is moved upward by making a rotation shaft 16a as a center, so that an uppermost sheet of the sheets Sb set to the intermediate plate 16 abuts on the feeding roller 17. Then, the feeding roller 17 rotates to feed the uppermost sheet. The separation roller 18 abuts on the feeding roller 17. Even in a case where two or more sheets Sb are fed by the feeding roller 17, the separation roller 18 prevents the sheets Sb other than the uppermost sheet from passing through, so that the sheets Sb are fed one by one. A sheet S that has passed through the feeding roller 17 and the separation roller 18 is conveyed to the registration roller pair 110 by the conveyance roller pair 19.

### Conveyance Path

A conveyance path included in the image forming apparatus 1 will now be described. In the present exemplary embodiment, a sheet S fed from the cassette 2 is conveyed to the registration roller pair 110 via a first conveyance path 20A (cassette feeding path) illustrated in FIG. 4. In contrast, a sheet S fed from the manual feeding unit 15 is conveyed to the registration roller pair 110 via a second conveyance path 20B (manual feeding path). In other words, the first conveyance path 20A and the second conveyance path 20B merge at a position on an upstream side of the registration roller pair 110.

The movable guide 13 according to the present exemplary embodiment is arranged on a junction of the first conveyance path 20A and the second conveyance path 20B. In other words, the movable guide 13 is arranged on the junction of the first conveyance path 20A, through which a sheet is conveyed to the registration roller pair 110 (conveyance unit) from the cassette 2, and the second conveyance path 20B, through which a sheet is conveyed to the registration roller pair 110 (conveyance unit) from a sheet supply source (manual feeding unit 15) different from the cassette 2.

In the present exemplary embodiment, at least a part of the first conveyance path 20A and at least a part of the second conveyance path 20B are included in the cassette 2. Specifically, the cassette 2 according to the present exemplary embodiment includes a first guide 12, a U-shape guide 21, and a second guide 22. The first guide 12 constitutes a part of the first conveyance path 20A. The U-shape guide 21 and the second guide 22 constitute a part of the second conveyance path 20B.

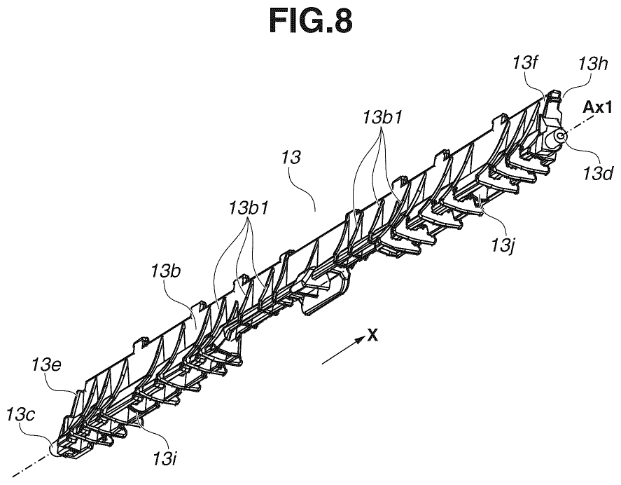

More specifically, the movable guide 13 provided in the apparatus main body 1A includes a first guide surface 13a (FIG. 1) and a second guide surface 13b (FIG. 8). The apparatus main body 1A also includes a first main body guide 61 and a second main body guide 62 (FIG. 4).

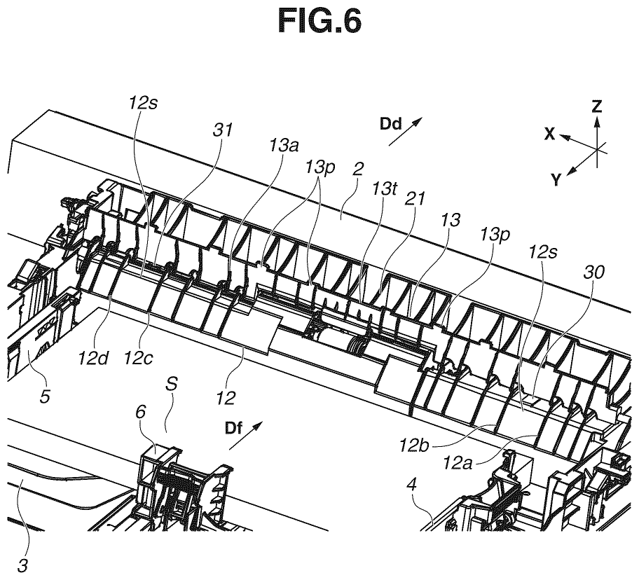

The first conveyance path 20A according to the present exemplary embodiment is a conveyance path formed by the first main body guide 61, the first guide 12 included in the cassette 2, and the first guide surface 13a of the movable guide 13. The first main body guide 61 guides an upper surface of the sheet fed from the cassette 2. The first guide 12 included in the cassette 2 and the first guide surface 13a of the movable guide 13 guide a lower surface of the sheet fed from the cassette 2 (also see FIG. 6). FIG. 6 is a perspective view illustrating a positional relationship of the cassette 2 mounted on the apparatus main body 1A and the movable guide 13.

The first conveyance path 20A is a conveyance path inclined upward toward the downstream side of the sheet feeding direction Df. The first guide 12 included in the cassette 2 and the first guide surface 13a included in the movable guide 13 are inclined upward toward the downstream side of the sheet feeding direction Df, so as to guide a leading end of the sheet fed from the cassette 2 to the upper side.

The second conveyance path 20B according to the present exemplary embodiment is a conveyance path formed by the second main body guide 62, the U-shape guide 21 and the second guide 22 included in the cassette 2, and the second guide surface 13b included in the movable guide 13. The second main body guide 62 guides an upper surface of the sheet fed from the manual feeding unit 15. The U-shape guide 21 and the second guide 22 included in the cassette 2 and the second guide surface 13b of the movable guide 13 guide a lower surface of the sheet fed from the manual feeding unit 15.

The second conveyance path 20B is a conveyance path curved to guide the sheet discharged to an obliquely lower side from the conveyance roller pair 19 to an obliquely upper side. A leading end of the sheet discharged from the conveyance roller pair 19 is sequentially guided by the U-shape guide 21 curved upward in a concave state, the second guide 22 inclined upward in the Y direction, and the second guide surface 13b of the movable guide 13 inclined upward in the Y direction, so that the sheet is guided to the upper side.

As described above, sheets fed from the plurality of sheet supply sources can smoothly be guided to the nip portion of the registration roller pair 110 by the guides 12, 21, and 22 arranged in the cassette 2 and the movable guide 13 arranged in the apparatus main body 1A.

In the present exemplary embodiment, the image forming apparatus 1 also includes an intra-cassette conveyance path 23 serving as a third conveyance path. The intra-cassette conveyance path 23 branches from the second conveyance path 20B, and extends to a lower side to open on a lower surface of the cassette 2. The intra-cassette conveyance path 23 is formed by a guide surface connected to the second guide 22 and a guide surface connected to the U-shape guide 21. In a case where an optional feeding device is to be coupled to a lower portion of the image forming apparatus 1, the intra-cassette conveyance path 23 functions as a conveyance path for receiving and guiding a sheet fed from the optional feeding device to the registration roller pair 110.

### Movable Guide

The movable guide 13 will be described with reference to FIGS. 1, 7, 8, and FIGS. 9A and 9B.

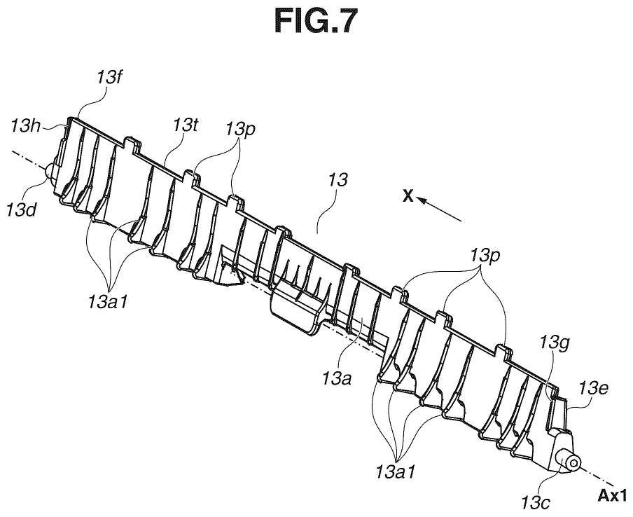

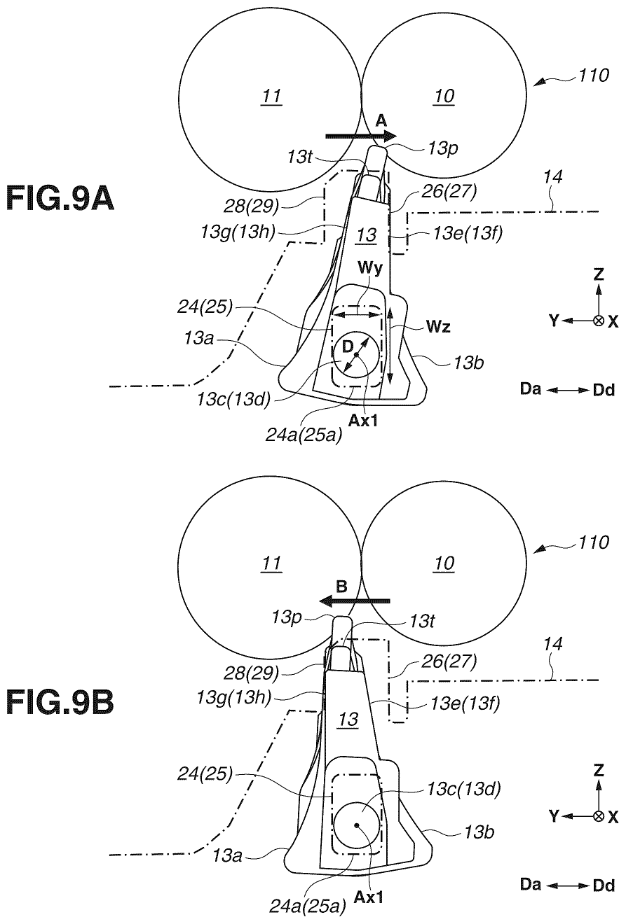

FIG. 1 is a perspective view illustrating a structure for supporting the movable guide 13. FIG. 7 is a perspective view illustrating the movable guide 13 viewed from a side of the first guide surface 13a. FIG. 8 is a perspective view illustrating the movable guide 13 viewed from a side of the second guide surface 13b. FIGS. 9A and 9B are schematic diagrams illustrating swing motion performed by the movable guide 13. In FIGS. 9A and 9B, the movable guide 13 and the registration roller pair 110 are viewed from the sheet width direction (X direction). In addition, a shape of the movable guide 13 according to the present exemplary embodiment is basically symmetric in the sheet width direction. In a case where only the configuration on one side of the movable guide 13 in the sheet width direction is described or illustrated in the drawings, the movable guide 13 therefore basically has the same configuration on another side thereof.

The movable guide 13 is a guide member for guiding a sheet fed from the cassette 2 by the feeding roller 7 (feeding unit). As illustrated in FIGS. 7 and 8, the movable guide 13 includes a first guide surface 13a, a second guide surface 13b, shaft portions 13c and 13d, first abutting portions 13e and 13f, second abutting portions 13g and 13h, and abutted portions 13i ad 13j. Hereinafter, the constituent elements of the movable guide 13 will be described, but the abutted portions 13i and 13j will be described below.

As illustrated in FIG. 7, the first guide surface 13a is a guide portion for guiding a sheet when the sheet is fed from the cassette 2 as described above. The first guide surface 13a extends in the sheet width direction (X direction), across the region (i.e., maximum sheet-passing region) where a sheet having a maximum size settable to the cassette 2 passes through. On the first guide surface 13a, a plurality of guide ribs 13a1 extending along the sheet-moving direction are also formed.

As illustrated in FIG. 8, the second guide surface 13b is a guide portion for guiding a sheet when the sheet is fed from the manual feeding unit 15 as described above. The second guide surface 13b extends in the sheet width direction (X direction), across the region (i.e., maximum sheet-passing region) where a sheet having a maximum size settable to the manual feeding tray passes through. On the second guide surface 13b, a plurality of guide ribs 13b1 extending along the sheet-moving direction are also formed.

As illustrated in FIG. 7, the shaft portions 13c and 13d projected in the sheet width direction (X direction) are provided on both end portions of the movable guide 13 in the sheet width direction (X direction). The shaft portions 13c and 13d are supported by a frame 14 (FIGS. 9A and 9B) that constitutes a frame body of the apparatus main body 1A.

The shaft portions 13c and 13d are swing fulcrum portions when the movable guide 13 swings, and the frame 14 is a supporting member for supporting the shaft portions 13c and 13d (swing fulcrum portions). The movable guide 13 according to the present exemplary embodiment swings around a swing axis line Ax1 extending between the shaft portions 13c and 13d in the sheet width direction (X direction), so as to be movable between a first posture, which is a posture when a sheet is fed from the cassette 2, and a second posture, which is a posture when a sheet is fed from the manual feeding unit 15, described below. In the present exemplary embodiment, the swing axis line Ax1 passes the center of the shaft portion 13c and the center of the shaft portion 13d.

The first abutting portions 13e and 13f and the second abutting portions 13g and 13h abut on part of the apparatus main body 1A to hold the movable guide 13 in the first posture or the second posture. As illustrated in FIGS. 9A and 9B, the frame 14 of the apparatus main body 1A includes first main body abutting portions 26 and 27 corresponding to the first abutting portions 13e and 13f of the movable guide 13, and second main body abutting portions 28 and 29 corresponding to the second abutting portions 13g and 13h of the movable guide 13.

As illustrated in FIGS. 7 and 8, in the present exemplary embodiment, the two first abutting portions 13e and 13f are arranged on one end and another end of the movable guide 13 in the sheet width direction (X direction). Correspondingly, the two first main body abutting portions 26 and 27 are arranged on the frame 14 of the apparatus main body 1A, at positions corresponding to the two first abutting portions 13e and 13f. As illustrated in FIG. 7, in the present exemplary embodiment, the two second abutting portions 13g and 13h are arranged on one end and another end of the movable guide 13 in the sheet width direction (X direction). Correspondingly, the two second main body abutting portions 28 and 29 are arranged on the frame 14 of the apparatus main body 1A, at positions corresponding to the two second abutting portions 13g and 13h.

The first abutting portions 13e and 13f and the second abutting portions 13g and 13h are provided at positions distant from the shaft portions 13c and 13d when viewed in the sheet width direction (X direction) (see FIG. 9A). In the present exemplary embodiment, the first abutting portions 13e and 13f and the second abutting portions 13g and 13h are arranged on the downstream side of the shaft portions 13c and 13d in the sheet conveyance direction, in which a sheet fed from the cassette 2 heads toward the nip portion of the registration roller pair 110.

The first abutting portions 13e and 13f are surfaces of the movable guide 13 facing on one side (-Y side) in the Y direction intersecting with both of the sheet width direction (X direction) and the sheet conveyance direction (substantially Z direction) defined at the nip portion of the registration roller pair 110. The second abutting portions 13g and 13h are surfaces of the movable guide 13 facing on another side (+Y side) in the Y direction.

### Swing Motion of Movable Guide

The movable guide 13 can swing between the first posture illustrated in FIG. 9A, in which the movable guide 13 guides a sheet conveyed in the first conveyance path 20A to the registration roller pair 110, and the second posture illustrated in FIG. 9B, in which the movable guide 13 guides a sheet conveyed in the second conveyance path 20B to the registration roller pair 110. In the first posture, a sheet fed from the cassette 2 is guided to the nip portion of the registration roller pair 110 by the first guide surface 13a. In the second posture, a sheet fed from the manual feeding unit 15 is guided to the nip portion of the registration roller pair 110 by the second guide surface 13b.

The movable guide 13 is in the first posture when the first abutting portions 13e and 13f of the movable guide 13 abut on the first main body abutting portions 26 and 27 of the frame 14. The movable guide 13 is in the second posture when the second abutting portions 13g and 13h of the movable guide 13 abut on the second main body abutting portions 28 and 29 of the frame 14.

In the present exemplary embodiment, the movable guide 13 can change the posture between the first posture and the second posture by being pressed by a sheet fed from the cassette 2 or the manual feeding unit 15.

Specifically, when a sheet fed from the cassette 2 is in contact with the first guide surface 13a of the movable guide 13 in a state where the movable guide 13 is in the second posture (FIG. 9B), the movable guide 13 is pressed by the sheet to swing in an arrow-A direction (i.e., clockwise direction) in FIG. 9A. The first abutting portions 13e and 13f then abut on the first main body abutting portions 26 and 27, so that the movable guide 13 is held in the first posture. In other words, the movable guide 13 is pressed by the sheet fed from the cassette 2, so as to change its posture from the second posture in FIG. 9B to the first posture in FIG. 9A.

Then, a leading end of the sheet is guided to the nip portion of the registration roller pair 110 with the first guide surface 13a of the movable guide 13 held in the first posture.

In contrast, when a sheet fed from the manual feeding unit 15 is in contact with the second guide surface 13b of the movable guide 13 in a state where the movable guide 13 is in the first posture (FIG. 9A), the movable guide 13 is pressed by the sheet to swing in an arrow-B direction (i.e., counterclockwise direction) in FIG. 9B. The second abutting portions 13g and 13h then abut on the second main body abutting portions 28 and 29, and thereby the movable guide 13 is held in the second posture. In other words, the movable guide 13 is pressed by the sheet fed from the manual feeding unit 15, thereby changing its posture from the first posture in FIG. 9A to the second posture in FIG. 9B. Then, a leading end of the sheet is guided to the nip portion of the registration roller pair 110 with the second guide surface 13b of the movable guide 13 held in the second posture.

The drive roller 10 included in the registration roller pair 110 according to the present exemplary embodiment consists of a plurality of rubber rollers arranged in the sheet width direction. Similarly to the drive roller 10, the driven roller 11 also consists of a plurality of rubber rollers arranged in the sheet width direction. Thus, the registration roller pair 110 forms a plurality of nip portions arranged at intervals in the sheet width direction. The nip portions are contact portions where the plurality of rubber rollers included in the drive roller 10 and the plurality of rubber rollers included in the driven roller 11 are in contact with each other.

Then, a plurality of convex portions 13p projecting to a downstream side of the sheet conveyance direction is formed on a leading end 13t of the movable guide 13. The leading end 13t is an end portion of the movable guide 13, located on the downstream side of the sheet conveyance direction defined at the nip portion of the registration roller pair 110. Each of the convex portions 13p, formed on the leading end 13t of the movable guide 13 extending in the sheet width direction, is located in a region between the plurality of nip portions of the registration roller pair 110 in the sheet width direction.

As illustrated in FIG. 9A, when the movable guide 13 held in the first posture is viewed in the sheet width direction, each of the convex portions 13p of the movable guide 13 overlaps with one of the rollers (i.e., drive roller 10) of the registration roller pair 110. Thus, even in a case where the position of the movable guide 13 relative to the position of the registration roller pair 110 is slightly changed because of assembly tolerance, the movable guide 13 can smoothly guide a sheet fed from the cassette 2 to the nip portion of the registration roller pair 110.

As illustrated in FIG. 9B, when the movable guide 13 held in the second posture is viewed in the sheet width direction, each of the convex portions 13p of the movable guide 13 overlaps with another one of the rollers (i.e., driven roller 11) of the registration roller pair 110. Thus, even in a case where the position of the movable guide 13 relative to the position of the registration roller pair 110 is slightly changed because of assembly tolerance or the like, the movable guide 13 can smoothly guide a sheet fed from the cassette 2 to the nip portion of the registration roller pair 110.

In the present exemplary embodiment, the movable guide 13 is maintained in the first posture or the second posture by own weight of the movable guide 13 during a time when the movable guide 13 is not pressed by the sheet. The movable guide 13 can be biased toward any one of the first posture and the second posture by a biasing unit such as a torsion coil spring, and moved to another one of the first posture and the second posture only when the movable guide 13 is being pressed by the sheet. The posture of the movable guide 13 can also be controlled by driving an actuator such as a solenoid.

### Structure for Supporting Movable Guide

Herein, the apparatus main body 1A according to the present exemplary embodiment will be described with respect to a structure for supporting the movable guide 13 in a movable state in the Z direction as a first direction. FIG. 1 is a perspective view illustrating a structure for supporting the movable guide 13.

As illustrated in FIG. 1, supporting grooves 24 and 25 functioning as supporting portions for supporting the shaft portions 13c and 13d of the movable guide 13 are provided on the frame 14 of the apparatus main body 1A. The supporting groove 24 supports the shaft portion 13c of the movable guide 13, whereas the supporting groove 25 supports the shaft portion 13d of the movable guide 13. The supporting grooves 24 and 25 according to the present exemplary embodiment are holes formed on the faces of the frame 14 extending in the Y and Z directions (i.e., faces extending in directions intersecting with the sheet width direction).

Hereinafter, a relationship between the shapes and the lengths of the shaft portion 13c and the supporting groove 24 arranged on one side in the sheet width direction will be described. In addition, a relationship between the shapes and the lengths of the shaft portion 13d and the supporting groove 25 arranged on another side in the sheet width direction is substantially the same as that of the shaft portion 13c and the supporting groove 24.

As illustrated in FIG. 9A, the shaft portion 13c (13d) of the movable guide 13 is a column-shaped member having a diameter D. The supporting groove 24 (25) formed on the frame 14 is an elongate hole having a width Wz in the Z direction longer than a width Wy in the Y direction.

The width Wy of the supporting groove 24 (25) in the Y direction is substantially the same as the diameter D of the shaft portion 13c (13d).

Movement of the shaft portion 13c (13d) of the movable guide 13 in the Y direction is thus regulated by the supporting groove 24 (25).

In contrast, the width Wz of the supporting groove 24 (25) in the Z direction is greater than the diameter D of the shaft portion 13c (13d). In other words, the supporting groove 24 (25) is a hole whose width Wz in the first direction (Z direction) is greater than the outer diameter (diameter D) of the shaft portion 13c (13d) of the movable guide 13. The shaft portion 13c (13d) of the movable guide 13 can therefore move in the Z direction along the supporting groove 24 (25). In other words, the movable guide 13 is supported by the apparatus main body 1A through the engagement of the shaft portion 13c (13d) and the supporting groove 24 (25), to be movable in the first direction.

In the present exemplary embodiment, the supporting groove 24 (25) extends in the Z direction, substantially. The first direction according to the present exemplary embodiment is therefore the Z direction. However, the first direction can be a direction different from the Z direction. For example, the first direction can be an obliquely upper right direction or an obliquely upper left direction in FIG. 9A. The first direction can be a direction intersecting with or desirably orthogonal to a lengthwise direction of the movable guide 13 (i.e., the sheet width direction or the X direction). The first direction can also be a direction intersecting with a moving direction (second direction) in which the movable guide 13 swings around the shaft portion 13c (13d). The moving direction (second direction), in which the movable guide 13 swings around the shaft portion 13c (13d), refers to a moving direction of the leading end 13t of the movable guide 13. In the present exemplary embodiment, the moving direction is substantially the Y direction. The first direction is a direction intersecting with or desirably orthogonal to the mounting direction Da and the draw-out direction Dd of the cassette 2.

A distance (Wz−D) the movable guide 13 can move in the Z direction (first direction) is regulated by a difference between the width Wz in the Z direction of the supporting groove 24 (25) and the diameter D of the shaft portion 13c (13d). The supporting groove 24 (25) and the shaft portion 13c (13d) are arranged to make the difference (Wz−D) be greater than a distance the movable guide 13 is moved at the time of mounting the cassette 2.

### Movement of Movable Guide at Time of Mounting Cassette

The abutted portions 13i and 13j of the movable guide 13 and movement of the movable guide 13 at the time of mounting the cassette 2 on the apparatus main body 1A will be described.

As illustrated in FIG. 8, the abutted portions 13i and 13j are arranged on the lower side of the movable guide 13. The abutted portions 13i and 13j abut on the cassette 2 in a mounted state of the cassette 2, so that a position of the movable guide 13 in the Z direction (first direction) is fixed.

In the present exemplary embodiment, the abutted portions 13i and 13j are end portions of the movable guide 13, located on the upstream side of the sheet conveyance direction defined the nip portion of the registration roller pair 110. The abutted portions 13i and 13j are also located on one side of the shaft portion 13c (13j), opposite to another side where the leading end 13t of the movable guide 13 is located, when viewed in the sheet width direction. The movable guide 13 according to the present exemplary embodiment includes the two abutted portions 13i and 13j arranged to face each other in the sheet width direction, across the central portion of the movable guide 13. However, the positions and the number of abutted portions 13i and 13j can be changed.

As illustrated in FIG. 5, the cassette 2 includes projecting portions 30 and 31 serving as abutting portions capable of abutting on the abutted portions 13i and 13j of the movable guide 13. The projecting portions 30 and 31 are arranged on an upper surface portion 2u of the cassette 2 and projected upward. The upper surface portion 2u of the cassette 2 is arranged between the above-described first guide 12 and the second guide 22 to face upward. In the present exemplary embodiment, the two projecting portions 30 and 31 corresponding to the two abutted portions 13i and 13j are arranged on the cassette 2.

On the first guide 12 and the upper surface portion 2u of the cassette 2, a plurality of ribs including ribs 12a, 12b, 12c, and 12d, serving as a plurality of guide ribs, is formed. These ribs 12a to 12d are projected to the upper side from a base surface of the first guide 12 and a base surface of the upper surface portion 2u, and extend in a conveyance direction of a sheet to be fed from the cassette 2. These ribs 12a to 12d function to smoothly convey a sheet by being in contact with the sheet fed from the cassette 2.

The projecting portion 30 is arranged between the two ribs 12a and 12b adjacent in the sheet width direction (X direction) on the inner side of the maximum sheet-passing region. The projecting portion 31 is arranged between the two ribs 12c and 12d adjacent in the sheet width direction (X direction) on the inner side of the maximum sheet-passing region. Upper surfaces of the projecting portions 30 and 31 can retract to the positions lower than the edge lines of the ribs 12a to 12d. This can prevent the ribs 12a to 12d arranged on the cassette 2 from interfering with the functions of the projecting portions 30 and 31, which are functions for moving the movable guide 13 by abutting on the abutted portions 13i and 13j of the movable guide 13.

A plurality of ribs adjacent with each other in the sheet width direction is also arranged on the first guide surface 13a of the movable guide 13. The ribs arranged on the first guide surface 13a of the movable guide 13 and the plurality of ribs arranged on the first guide 12 and the upper surface portion 2u of the cassette 2 are arranged at positions mutually shifted in the sheet width direction, so that the ribs are not in contact with each other when the cassette 2 is attached or removed.

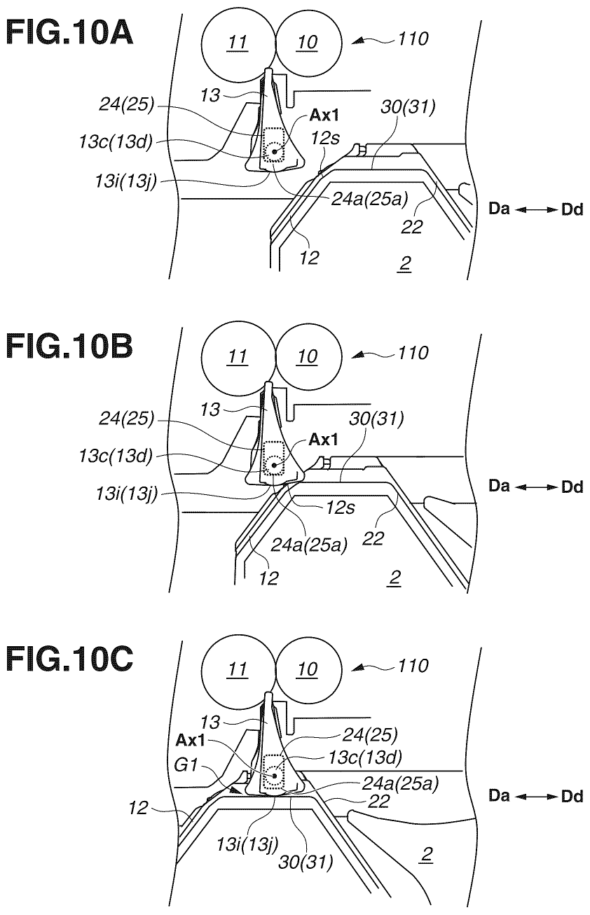

Movement of the movable guide 13 at the time of mounting the cassette 2 will now be described with reference to FIGS. 10A to 10C. FIG. 10A is a schematic diagram illustrating a state where the cassette 2 drawn out from the apparatus main body 1A is halfway inserted to the housed position in the mounting direction Da. FIG. 10C is a schematic diagram illustrating a state (a mounted state of the cassette 2) where the cassette 2 is mounted on the housed position. FIG. 10B is a schematic diagram illustrating a state between the states illustrated in FIGS. 10A and 10C.

As illustrated in FIG. 10A, in a state before the cassette 2 is mounted on the apparatus main body 1A, the movable guide 13 is held in a state where the shaft portion 13c (13d) abuts on a lower end 24a (25a) of the supporting groove 24 (25) of the frame 14. In the above-described state, the abutted portion 13i (13j) is located at a position lower than a position of the projecting portion 30 (31) in the Z direction. In a direction orthogonal to the swing axis line Ax1 of the movable guide 13, the abutted portion 13i (13j) is closer to the swing axis line Ax1 than the downstream end of the movable guide 13 (the leading end 13t or the convex portion 13p) in the sheet conveyance direction. In other words, in a direction orthogonal to the swing axis line Ax1 of the movable guide 13, a distance between the abutted portion 13i (13j) and the swing axis line Ax1 is shorter than a distance between the downstream end of the movable guide 13 (the leading end 13t or the convex portion 13p) in the sheet conveyance direction and the swing axis line Ax1.

When the cassette 2 is moved in the mounting direction Da, the first guide 12 of the cassette 2 abuts on the lower surface of the movable guide 13 as illustrated in FIG. 10B. At this stage, portions abutting on the movable guide 13 are part of the first guide 12, which are inclined surfaces 12s (FIG. 6) located on the downstream side of the projecting portions 30 and 31 in the mounting direction Da. Each of the inclined surfaces 12s is an example of a contact portion, which is in contact with the movable guide 13 to make the movable guide 13 move in the Z direction (first direction) in a process of making the cassette 2 be mounted on the apparatus main body 1A.

In the present exemplary embodiment, each of the inclined surfaces 12s is inclined downward to the downstream side of the mounting direction Da. In other words, each of the inclined surfaces 12s is inclined upward to the downstream side of the draw-out direction Dd.

The movable guide 13 is therefore moved upward by the inclined surfaces 12s in tandem with the operation for inserting the cassette 2 to the apparatus main body 1A in the mounting direction Da opposite to the draw-out direction Dd. As a result, the shaft portion 13c (13d) of the movable guide 13 is separated from the lower end 24a (25a) of the supporting groove 24 (25).

When the cassette 2 is further inserted to reach the housed position, the abutted portion 13i (13j) of the movable guide 13 runs onto the projecting portion 30 (31) of the cassette 2 as illustrated in FIG. 10C. In other words, in a state where the cassette 2 is mounted on the apparatus main body 1A, a position of the movable guide 13 in the first direction (Z direction) is fixed by the cassette 2. The movable guide 13 can swing between the above-described first posture (FIG. 9A) and the second posture (FIG. 9B) in a state where the abutted portion 13i (13j) is in contact with the projecting portion 30 (31).

When the cassette 2 mounted on the apparatus main body 1A is to be drawn out, the movable guide 13 moves through a process opposite to the above-described process the movable guide 13 has gone through at the time of mounting the cassette 2. In other words, when the cassette 2 is drawn out in the draw-out direction Dd from the state illustrated in FIG. 10C, the projecting portion 30 (31) of the cassette 2 is separated from the abutted portion 13i (13j) of the movable guide 13. The movable guide 13 is moved downward along the inclination of the first guide 12 as illustrated in FIG. 10B. When the cassette 2 is further drawn out in the draw-out direction Dd, the movable guide 13 is held in a state where the shaft portion 13c (13d) abuts on the lower end 24a (25a) of the supporting groove 24 (25) as illustrated in FIG. 10A.

### Summary of the Present Exemplary Embodiment

In the present exemplary embodiment, the movable guide 13 for guiding a sheet fed by the feeding roller 7 is supported by the apparatus main body 1A, so as to be movable in the first direction (Z direction). In a state where the cassette 2 is located at the housed position, the movable guide 13 is arranged on the downstream side of the accommodating portion 2a of the cassette 2 in the draw-out direction Dd. The movable guide 13 is then moved in the first direction (Z direction) by the cassette 2, in the process of making the cassette 2 be mounted on the apparatus main body 1A.

With this configuration, the movable guide 13 arranged on the apparatus main body 1A can be arranged close to the cassette 2.

When the movable guide 13 is arranged close to the cassette 2, for example, a sheet fed from the cassette 2 can be conveyed to the movable guide 13 more smoothly, and there is an advantage that the sheet feeding operation can be executed more stably.

In the present exemplary embodiment, a position of the movable guide 13 is fixed by the cassette 2 in the first direction (Z direction) in a state where the cassette 2 is mounted on the apparatus main body 1A. Thus, relative positional accuracy of the cassette 2 and the movable guide 13 in the first direction (Z direction) is improved, so that a sheet fed from the cassette 2 can be conveyed to the movable guide 13 more smoothly.

The first guide 12 serving as an upstream guide is also arranged on the cassette 2. The first guide 12 guides a sheet on the upstream side of the movable guide 13 in the sheet conveyance direction, in a state where the cassette 2 is mounted on the apparatus main body 1A. When the movable guide 13 is arranged close to the cassette 2, it is possible to reduce a gap G1 (FIG. 10C) between the first guide 12 of the cassette 2 and the movable guide 13 of the apparatus main body 1A.

The sheet feeding device for feeding a sheet from the cassette 2 drawable from the apparatus main body 1A typically has a gap (clearance) set between a guide on a cassette 2 side and a guide on an apparatus main body 1A side. This gap is set as a margin for preventing the above-described guides from interfering with each other when the cassette 2 is to be attached or detached, even in a case where the components have a tolerance, slight deformation during shipment, or operational unsteadiness. However, in a case where a sheet is caught by the gap between the guides, this may cause a jam (paper jam) to occur. Further, to prevent a leading end of a sheet from being caught by the gap, there may be a case where a step is formed by making the upstream end of the downstream guide retract from the downstream end of the upstream guide. However, when a sheet having high stiffness, such as thick paper, is conveyed, a lower end of the sheet may be bounced by the step to make a sound (bouncing sound).

According to the present exemplary embodiment, the gap G1 between the first guide 12 of the cassette 2 and the movable guide 13 of the apparatus main body 1A can be reduced. It is thereby possible to reduce a possibility of occurrence of a jam (paper jam). Further, because the gap G1 can be reduced, the step between the first guide 12 and the movable guide 13 for preventing occurrence of a jam (paper jam) can also be reduced. It is therefore possible to reduce the bouncing sound generated during conveyance of the sheet.

In the present exemplary embodiment, the contact portions (inclined surfaces 12s) of the cassette 2, which are in contact with the movable guide 13 in the process of making the cassette 2 be mounted on the apparatus main body 1A, are also arranged in the regions between the ribs 12a, 12b, 12c, and 12d arranged on the first guide 12. Even in a case where a frictional dent is formed on the inclined surface 12s due to contact with the movable guide 13, sheet conveyance can therefore be executed without being affected by the frictional dent. Further, a size of the image forming apparatus 1 in the sheet width direction can also be smaller when compared to the case where the contact portions of the cassette 2, which are in contact with the movable guide 13 in the process of making the cassette 2 be mounted on the apparatus main body 1A, are arranged on the outer side of the the maximum sheet-passing region in the sheet width direction. Herein, the maximum sheet-passing region refers to a range in the sheet width direction where a sheet having a maximum length in the sheet width direction settable to the cassette 2 passes through.

Through the configuration according to the present exemplary embodiment, a space used to arrange the cassette 2 and the movable guide 13 can be saved, for example, when compared to the configuration in which the movable guide 13 is arranged at a position higher than a position described in the present exemplary embodiment and the movable guide 13 is not in contact with the cassette 2 at the time of mounting the cassette 2. It is thereby possible to reduce a size of the image forming apparatus 1.

In a second exemplary embodiment, configuration of the movable guide 13, different from the first exemplary embodiment will be described. Configurations of the sheet feeding device 1F except for the configuration of the movable guide 13 and an entire configuration of the image forming apparatus 1 can be similar to the configuration described in the first exemplary embodiment. Hereinafter, it is assumed that, unless otherwise specified, elements with reference numerals common to those in the first exemplary embodiment have configuration and functions basically the same as those in the first exemplary embodiment, and configurations different from the first exemplary embodiment will mainly be described.

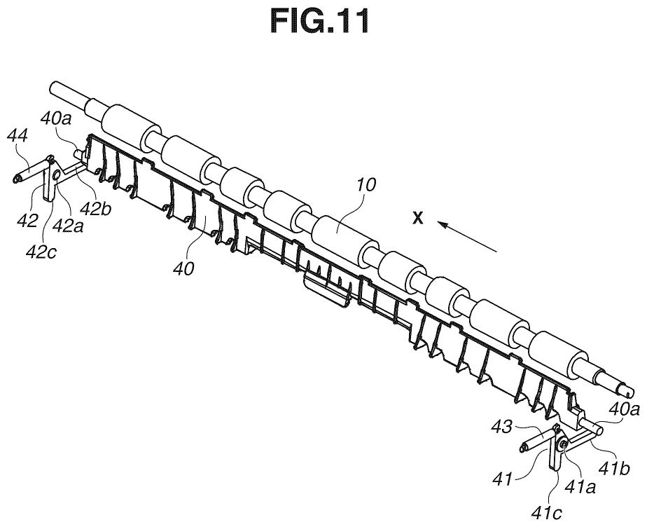

FIG. 11 is a perspective view illustrating a movable guide 40 and a drive roller 10 of the registration roller pair 110 according to the present exemplary embodiment. Levers 41 and 42, and springs 43 and 44, functioning as an interlocking mechanism for making the movable guide 40 move interlocking with attachment and detachment of the cassette 2, are arranged in vicinities of both ends of the movable guide 40 in the sheet width direction (X direction). The levers 41 and 42 are arranged on the apparatus main body 1A. The springs 43 and 44 are biasing members for biasing the levers 41 and 42. In the present exemplary embodiment, extension springs are used as the springs 43 and 44.

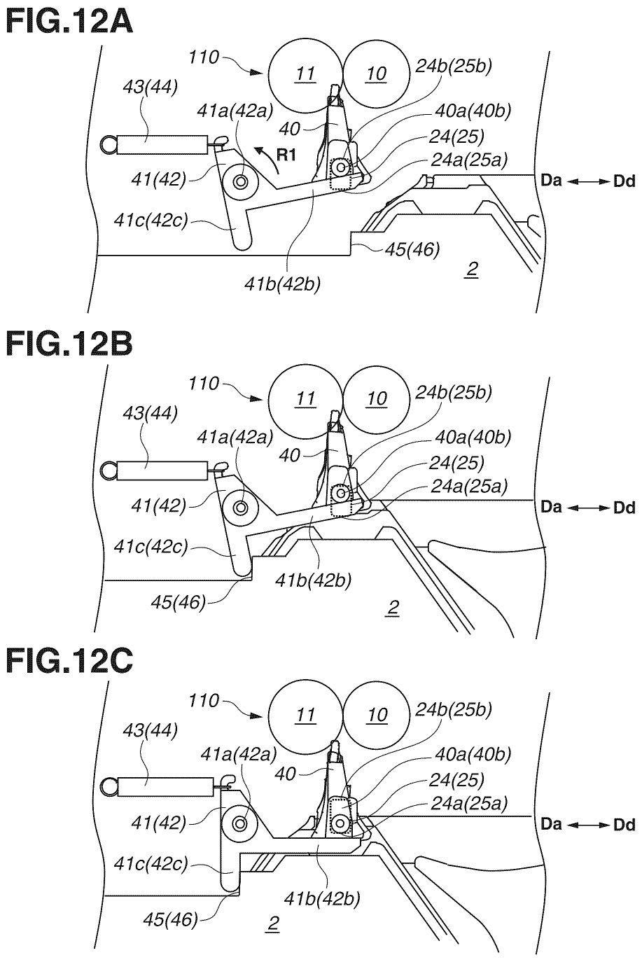

The lever 41 (42) includes a shaft portion 41a (42a), a first arm portion 41b (42b), and a second arm portion 41c (42c). The lever 41 (42) is rotatable about the shaft portion 41a (42a) extending in the sheet width direction (X direction). The first arm portion 41b (42b) is an engaging portion that engages with a shaft portion 40a projected from both ends of the movable guide 40 in the sheet width direction (X direction). The second arm portions 41c and 42c are abutted portions (pressed portions) where pressing portions 45 and 46 (FIGS. 12A to 12C) arranged on the cassette 2 abut on. The lever 41 (42) is biased by the corresponding spring 43 (44) in a rotation direction R1, in which the first arm portion 41b (42b) presses the shaft portion 40a (40b) of the movable guide 40 upward.

Similarly to the movable guide 13 according to the first exemplary embodiment, the movable guide 40 according to the present exemplary embodiment is supported by the apparatus main body 1A by making the shaft portions 40a and 40b be engaged with the supporting grooves 24 and 25 of the frame 14 (see FIG. 1). The movable guide 40 is thereby movable in the Z direction (first direction) and swingable about the shaft portions 40a and 40b in a swing direction (second direction).

Movement of the movable guide 40 at the time of mounting the cassette 2 will now be described with reference to FIGS. 12A to 12C. Although the configuration and the movement on one side of the movable guide 40 in the sheet width direction (X direction) are illustrated in FIGS. 12A to 12C, the configuration and the movement on another side of the movable guide 40 are basically the same as those illustrated in FIGS. 12A to 12C.

As illustrated in FIG. 12A, before the cassette 2 is mounted on the apparatus main body 1A, the movable guide 40 is held in a state where the shaft portion 13c (13d) abuts on an upper end 24b (25b) of the supporting groove 24 (25) of the frame 14 because of the biasing force received from the spring 43 (44). More specifically, the first arm portion 41b (42b) of the lever 41 (42) moves the shaft portion 40a (40b) of the movable guide 40 upward in the Z direction with the biasing force received from the spring 43 (44).

When the cassette 2 is moved in the mounting direction Da, the pressing portion 45 (46) of the cassette 2 abuts on the second arm portion 41c (42c) of the lever 41 (42) as illustrated in FIG. 12B. When the second arm portion 41c (42c) is pressed, the lever 41 (42) thereby rotates clockwise in FIG. 12B against the biasing force of the spring 43 (44). The lever 41 (42) rotates to cause the first arm portion 41b (42b) to move downward, and the movable guide 40 moves downward by its own weight along the supporting groove 24 (25).

When the cassette 2 is further inserted to reach the housed position, the shaft portion 40a (40b) of the movable guide 40 abuts on the lower end 24a (25a) of the supporting groove 24 (25) as illustrated in FIG. 12C.

When the cassette 2 mounted on the apparatus main body 1A is to be drawn out, the movable guide 40 moves through a process opposite to the above-described process the movable guide 40 has gone through at the time of mounting the cassette 2. In other words, when the cassette 2 is drawn out in the draw-out direction Dd from the state illustrated in FIG. 12C, the pressing portion 45 (46) of the cassette 2 retracts from the second arm portion 41c (42c) of the lever 41 (42). The lever 41 (42) then rotates counterclockwise in FIG. 12C according to the biasing force of the spring 43 (44), so that the first arm portion 41b (42b) makes the shaft portion 40a (40b) of the movable guide 40 move upward (FIG. 12A).

### Summary of the Present Exemplary Embodiment

In the present exemplary embodiment, the movable guide 40 for guiding a sheet fed by the feeding roller 7 is supported by the apparatus main body 1A to be movable in the first direction (Z direction). In a state where the cassette 2 is located at the housed position, the movable guide 40 is arranged on the downstream side of the accommodating portion 2a of the cassette 2 in the draw-out direction Dd. The movable guide 40 is then moved in the first direction (Z direction) by the cassette 2, in the process of making the cassette 2 be mounted on the apparatus main body 1A.

With this configuration, the movable guide 40 arranged on the apparatus main body 1A can be arranged close to the cassette 2. Further, a gap and a step between the first guide 12 of the cassette 2 and the movable guide 40 of the apparatus main body 1A can also be reduced. It is thereby possible to reduce a possibility of occurrence of a jam (paper jam) and a bouncing sound made by a trailing end of the sheet.

According to the present exemplary embodiment, the lever 41 (42), which is arranged on the apparatus main body 1A and functions as an interlocking member, makes the movement of the cassette 2 in the mounting direction Da be transformed to the movement of the movable guide 40 in the Z direction (first direction). The movable guide 40 can thereby be moved in the Z direction (first direction) interlocking with the attachment and detachment of the cassette 2, even in a case where it is difficult to implement the configuration described in the first exemplary embodiment, in which the movable guide 13 is moved by making part of the cassette 2, e.g., the inclined surfaces 12s, be directly in contact with the movable guide 13.

In a third exemplary embodiment, configuration of the movable guide 13 that is different from the first exemplary embodiment will be described. Configurations of the sheet feeding device 1F except for the configuration of the movable guide 13 and an entire configuration of the image forming apparatus 1 can be similar to the configuration described in the first exemplary embodiment. Hereinafter, it is assumed that, unless otherwise specified, elements with reference numerals common to those in the first exemplary embodiment have configuration and functions basically the same as those in the first exemplary embodiment, and configurations different from the first exemplary embodiment will mainly be described.

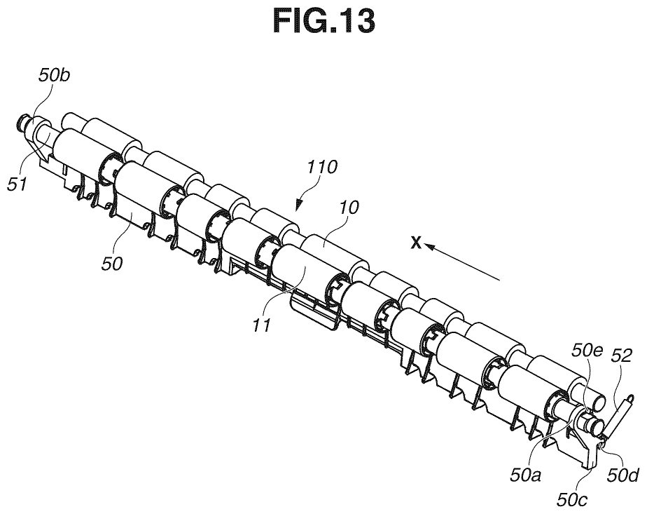

FIG. 13 is a perspective view illustrating a movable guide 50 and the registration roller pair 110 according to the present exemplary embodiment.

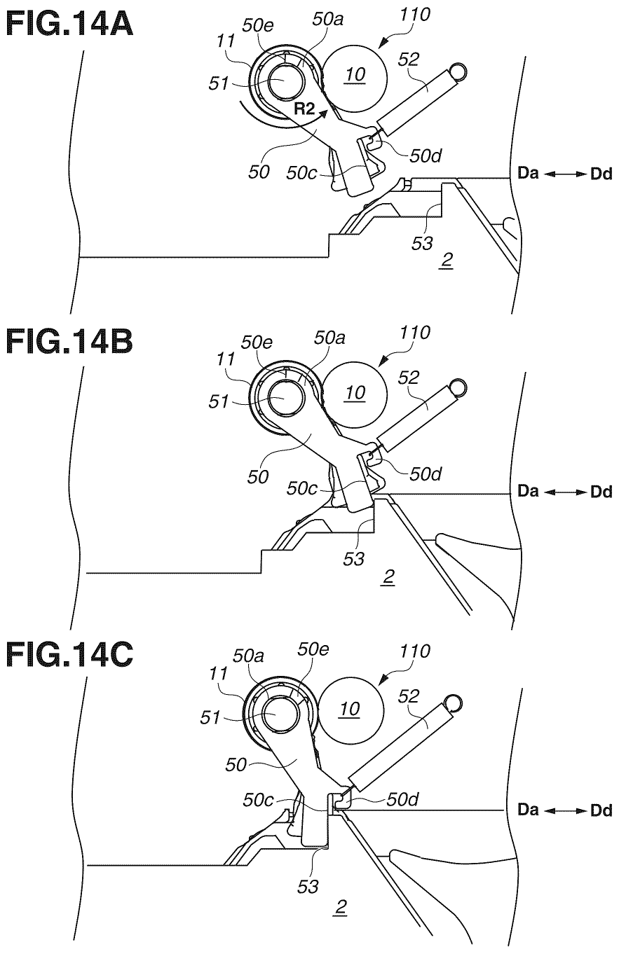

Attachment portions 50a and 50b are provided on both ends of the movable guide 50 in the sheet width direction (X direction). On each of the attachment portions 50a and 50b, a hole is formed to which a roller shaft 51 of the driven roller 11 of the registration roller pair 110 is inserted. By making the roller shaft 51 be inserted to the holes formed on the attachment portions 50a and 50b, the movable guide 50 can swing around a roller shaft 51 in a swing direction R2 (FIG. 14A). In other words, the movable guide 50 according to the present exemplary embodiment swings in the first direction (swing direction R2), around the roller shaft 51 of a conveyance roller (driven roller 11) for conveying a sheet guided and conveyed by the movable guide 50.

The roller shaft 51 is rotatably held by the frame of the apparatus main body 1A. That is, the movable guide 50 is supported by the apparatus main body 1A to be movable in the swing direction R2 serving as the first direction.

The movable guide 50 according to the present exemplary embodiment does not possess the function for swinging between the first posture and the second posture, possessed by the movable guides 13 and 40 described in the first and the second exemplary embodiment. In other words, the movable guide 50 cannot swing in the second direction different from the first direction (swing direction R2).

In FIG. 13, the attachment portion 50a includes an abutting portion 50c, a spring hook portion 50d, and a stopper portion 50e. The abutting portion 50c is pressed by the pressing portion 53 (FIG. 14B) of the cassette 2 at the time of mounting the cassette 2. One end of a spring 52 (extension spring) is connected to the spring hook portion 50d. Another end of the spring 52 is connected to the frame of the apparatus main body 1A. The movable guide 50 is biased by the spring 52 in the predetermined swing direction R2 (FIG. 14A) around the roller shaft 51. The stopper portion 50e can abut on the abutting portion of the apparatus main body 1A.

Movement of the movable guide 50 at the time of mounting the cassette 2 will now be described with reference to FIGS. 14A to 14C. Although the configuration and the movement on one side of the movable guide 50 in the sheet width direction (X direction) are illustrated in FIGS. 14A to 14C, the configuration and the movement on another side of the movable guide 50 are basically the same as those illustrated in FIGS. 14A to 14C.

As illustrated in FIG. 14A, before the cassette 2 is mounted on the apparatus main body 1A, the movable guide 50 is located at a position in which the movable guide 50 has rotated in the swing direction R2 by the biasing force of the spring 52. In this state, the stopper portion 50e abuts on the abutting portion of the apparatus main body 1A, so that further rotation of the movable guide 50 in the swing direction R2 is regulated.

When the cassette 2 is moved in the mounting direction Da, the pressing portion 53 of the cassette 2 abuts on the abutting portion 50c of the attachment portion 50a as illustrated in FIG. 14B. The abutting portion 50c is pressed by the pressing portion 53, the movable guide 50 swings around the roller shaft 51 clockwise in FIG. 14B, against the biasing force of the spring 52.

When the cassette 2 is inserted to reach the housed position, as illustrated in FIG. 14C, a position of the movable guide 50 is fixed in a state where the pressing portion 53 of the cassette 2 abuts on the abutting portion 50c of the attachment portion 50a.

### Summary of the Present Exemplary Embodiment

In the present exemplary embodiment, the movable guide 50 for guiding a sheet fed by the feeding roller 7 is supported movably in the first direction (swing direction R2) by the apparatus main body 1A. In a state where the cassette 2 is located at the housed position, the movable guide 50 is arranged on the downstream side of the accommodating portion 2a of the cassette 2 in the draw-out direction Dd. The movable guide 50 is then moved in the first direction (Z direction) by the cassette 2, in the process of making the cassette 2 be mounted on the apparatus main body 1A.

With this configuration, the movable guide 50 arranged on the apparatus main body 1A can be arranged closely to the cassette 2. This configuration can also reduce a gap and a step between the first guide 12 of the cassette 2 and the movable guide 50 of the apparatus main body 1A. It is thus possible to reduce a possibility of occurrence of a jam (paper jam) and a bouncing sound made by a trailing end of the sheet.

The movable guide 50 according to the present exemplary embodiment does not have the function for swinging between the first posture and the second posture described in the first and the second exemplary embodiments. However, it is possible to make the movable guide 50 move interlocking with the attachment and detachment of the cassette 2, through the configuration simpler than the configuration described in the first and the second exemplary embodiments. For example, there is a case where the image forming apparatus 1 does not include the manual feeding unit 15 and the second conveyance path 20B (FIG. 4) for manual feeding. There is another case where a countermeasure against bouncing of a trailing end of the sheet can separately be implemented because a distance between the movable guide 50 and the registration roller pair 110 is sufficient. In the above-described cases, the configuration according to the present exemplary embodiment is effective because a negative effect such as the bouncing of the trailing end of the sheet is less likely to occur even in a case where the movable guide 50 does not swing between the first posture and the second posture, as described in the present exemplary embodiment.

In the above-described exemplary embodiments, the sheet feeding device 1F built into the image forming apparatus 1 has been described. However, the present disclosure is not limited thereto, and the technique according to the present disclosure can be applied to a sheet feeding device having a housing independent from the apparatus main body 1A (housing) of the image forming apparatus 1, which is coupled to the apparatus main body 1A to be capable of feeding a sheet to the image forming apparatus 1. In this case, “apparatus main body” can be a housing of the sheet feeding device coupled to the apparatus main body 1A of the image forming apparatus 1.

According to the present disclosure, it is possible to provide an image forming apparatus in which a movable guide arranged on the apparatus main body can be arranged closely to the cassette.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-133936, filed Aug. 9, 2024, which is hereby incorporated by reference herein in its entirety.

What is claimed is:

1. A sheet feeding device comprising:
a device main body;
a cassette including an accommodating portion configured to accommodate sheets, the cassette being mounted on the device main body to be drawable in a draw-out direction from a housed position;
a feeding member configured to feed a sheet accommodated in the accommodating portion to a downstream side in the draw-out direction; and
a movable guide configured to guide the sheet fed by the feeding member, the movable guide being supported by the device main body to be movable in a first direction, the movable guide being arranged on a downstream side of the accommodating portion in the draw-out direction in a state where the cassette is located at the housed position,
wherein, in a process of mounting the cassette on the device main body, the movable guide is moved in the first direction by the cassette.

2. The sheet feeding device according to claim 1, wherein the movable guide is swingable in a second direction different from the first direction.

3. The sheet feeding device according to claim 2, wherein the device main body has a supporting member, the supporting member supporting a swing fulcrum portion when the movable guide swings in the second direction, such that the swing fulcrum portion is swingable and movable in the first direction.

4. The sheet feeding device according to claim 3,
wherein the swing fulcrum portion is a shaft portion of the movable guide extending in a direction of a swing axis line, and
wherein the supporting member has a hole with which the shaft portion is engaged, the hole having a width in the first direction larger than an outer diameter of the shaft portion.

5. The sheet feeding device according to claim 1, further comprising a conveyance unit configured to convey the sheet,
wherein the movable guide is arranged at a junction of a first conveyance path, through which the sheet is conveyed to the conveyance unit from the cassette, and a second conveyance path, through which the sheet is conveyed to the conveyance unit from a sheet supply source different from the cassette.

6. The sheet feeding device according to claim 5, wherein the movable guide is swingable between a first posture, at which the movable guide guides the sheet conveyed through the first conveyance path to the conveyance unit, and a second posture, at which the movable guide guides the sheet conveyed through the second conveyance path to the conveyance unit.

7. The sheet feeding device according to claim 1, wherein, in a state where the cassette is mounted on the housed position, the movable guide is positioned by the cassette with respect to the first direction.

8. The sheet feeding device according to claim 1, wherein the cassette includes an upstream guide arranged on an upstream side of the movable guide in a sheet feeding direction in which the sheet is fed by the feeding member.

9. The sheet feeding device according to claim 1,
wherein the cassette includes an upper surface portion facing upward and a projecting portion arranged on the upper surface portion and projected upward, and
wherein, in a state where the cassette is mounted on the device main body, the projecting portion abuts on the movable guide to position the movable guide with respect to the first direction.

10. The sheet feeding device according to claim 9,
wherein the cassette includes a plurality of guide ribs arranged on the upper surface portion, the plurality of guide ribs being adjacent with each other in a sheet width direction orthogonal to the sheet feeding direction of the feeding member, each of the plurality of guide ribs extending along the sheet feeding direction,
wherein, in the sheet width direction, the projecting portion is arranged on an inner side of a region where a sheet having a maximum size settable to the cassette passes through, the projecting portion being arranged between the plurality of guide ribs, and
wherein an upper surface of the projecting portion is located at a position lower than edge lines of the plurality of guide ribs.

11. The sheet feeding device according to claim 1, wherein the cassette includes a contact portion, the contact portion being in contact with the movable guide to make the movable guide move in the first direction in the process of mounting the cassette on the device main body.

12. The sheet feeding device according to claim 11,
wherein the contact portion is an inclined surface inclined upward to an upstream side of the draw-out direction, and
wherein the movable guide is moved upward by the inclined surface interlocking with an operation for inserting the cassette into the device main body in a mounting direction opposite to the draw-out direction.

13. The sheet feeding device according to claim 12,
wherein the cassette includes an upstream guide, the upstream guide being arranged on an upstream side of the movable guide in the sheet feeding direction of the feeding member,
wherein the upstream guide includes a plurality of guide ribs, the plurality of guide ribs being adjacent with each other in a sheet width direction orthogonal to the sheet feeding direction, each of the plurality of guide ribs extending along the sheet feeding direction, and
wherein the inclined surface is arranged between the plurality of guide ribs in the sheet width direction.

14. The sheet feeding device according to claim 1, further comprising an interlocking mechanism arranged on the device main body, the interlocking mechanism including an engaging portion engaging with the movable guide and an abutted portion where the cassette abuts on, the abutted portion being pressed by the cassette to cause the interlocking mechanism to make the movable guide move in the first direction, interlocking with mounting of the cassette on the device main body.

15. The sheet feeding device according to claim 14, wherein the interlocking mechanism includes lever on which the engaging portion and the abutted portion are arranged, the lever being rotatably supported by the device main body.

16. The sheet feeding device according to claim 1, further comprising a conveyance roller configured to convey the sheet guided and conveyed by the movable guide,
wherein the movable guide swings around a roller shaft of the conveyance roller in the first direction.

17. An image forming apparatus comprising:
the sheet feeding device according to claim 1; and
an image forming unit configured to form an image on the sheet fed by the sheet feeding device.
